(19) United States
(12) Patent Application Publication
(10) Pub. No.: US 2021/0204019 A1
(43) Pub. Date: Jul. 1, 2021

(54) VIRTUAL REALITY BUFFERING

(71) Applicant: HEWLETT-PACKARD DEVELOPMENT COMPANY, L.P., Spring, TX (US)

(72) Inventors: Isaac LAGNADO, Houston, TX (US); Chung-Chun CHEN, Taipei City (TW); Yi-Kang HSIEH, Taipei City (TW)

(73) Assignee: HEWLETT-PACKARD DEVELOPMENT COMPANY, L.P., Houston, TX (US)

(21) Appl. No.: 16/076,204

(22) PCT Filed: Jul. 18, 2017
(86) PCT No.: PCT/US2017/042601

§ 371 Date: Aug. 7, 2018

(51) Int. Cl. H04N 21/4363; H04N 21/81; H04N 21/44; H04N 21/414; H04N 21/4402; H04N 21/442

(52) U.S. Cl. CPC H04N 21/43637; H04N 21/816; H04N 21/44218; H04N 21/41407; H04N 21/440245; H04N 21/44004

(57) ABSTRACT

Example implementations relate to virtual reality buffering. In some examples, a wireless system may include a wearable display and instructions executable by a processor. The instructions may be executable by a processor to assign a first portion of a total bandwidth, associated with wirelessly delivering a virtual reality (VR) video stream to the wearable display, to instantiate of an image of an active region of the VR video stream on the wearable display. The instructions may be executable by a processor to assign a second portion of the total bandwidth to buffering a peripheral region of the video stream.

### BACKGROUND

Virtual reality (VR) is a technology that utilizes immersive displays to generate realistic images, sounds, and other sensations that simulate a user's physical presence in a virtual environment. A user utilizing VR equipment may be able to look around, move around, and interact with an artificial environment utilizing the immersive displays.

### BRIEF DESCRIPTION OF THE DRAWINGS

FIG. 1 illustrates an example of a system for virtual reality buffering consistent with the disclosure.

FIG. 2 illustrates an example of a virtual environment for virtual reality buffering consistent with the disclosure.

FIG. 3 illustrates an example of a virtual environment for virtual reality buffering consistent with the disclosure.

FIG. 4 illustrates an example of a virtual environment for virtual reality buffering consistent with the disclosure.

FIG. 5 illustrates an example of a virtual environment consistent with the disclosure.

FIG. 6 illustrates a diagram of an example of a processing resource and a non-transitory machine readable storage medium for virtual reality buffering consistent with the disclosure.

FIG. 7 illustrates a flow diagram of an example of a method 750 for virtual reality buffering consistent with the disclosure.

### DETAILED DESCRIPTION

Virtual reality (VR) may include covering a portion of a user's eyes and/or field of vision and providing a user with visual stimuli via a display, thereby substituting a “virtual” reality for actual reality. A VR system may allow the user to interact with the “virtual” reality through games, educational activities, group activities, and the like. As used herein, the term virtual reality is also intended to be inclusive of augmented reality (AR). Augmented reality may provide an overlay transparent or semitransparent screen in front of and facing a user's eyes such that reality is “augmented” with additional information such as graphical representations and/or supplemental data. For example, an AR system may overlay transparent or semi-transparent weather information, direction, and/or other information on an AR display for a user to examine. References to VR (e.g., VR headsets, VR video streams, VR, VR images, etc.) throughout the disclosure should be understood to be inclusive of their augmented reality counterparts.

A user may experience virtual reality and/or augmented reality by utilizing VR devices. A VR device may include a VR headset. A VR headset may include a computing device including a processing resource such as electronic circuitry to execute instructions stored on machine-readable medium to perform various operations. The VR headset may include a head mounted wearable display for displaying images to a user. The wearable display may be a stereoscopic display. The processing resource may execute instructions stored on machine-readable medium to receive data including images or video streams of a virtual environment and instantiate a graphical representation of the data on the wearable display. That is, the VR headset may receive images and/or video of making up a portion of a virtual environment and cause the images to be displayed to a user via the wearable display.

VR headsets may include a variety of sensors for tracking user movement. For example, a VR headset may include a gyroscope, accelerometer, eye track sensors, structured light system, input devices, buttons, joysticks, pressure sensors, etc. for detecting user movement relative to the wearable display and/or relative to the physical environment where the user is located. The detected movement of the user may be utilized to alter the information displayed on the wearable display. Specifically, the detected movement of the user may be translated to a corresponding virtual movement in the virtual environment being displayed on the wearable display. The image or change in image corresponding to the virtual movement in the virtual environment may then be displayed on the wearable display. In this manner an immersive user experience may be created whereby the user perceives that they are actually interacting with the virtual environment and/or are in physically in the virtual environment by virtue of the correlation between their movements and a changed perspective of the virtual environment.

However, VR headsets that are stationary, bulky relative to a user's head, and/or tethered to additional equipment such as a stationary computing device, storage medium, power source, or wired data connection may restrict a user's ability to freely move. Such constraints may detract from the immersive nature of VR headsets. That is, a user's perception that they are actually interacting with the virtual environment and/or are in physically in the virtual environment may be diminished by virtue of an impinged ability to freely move. These restrictions may serve as a constant reminder to the user that they are not actually interacting with the virtual environment and/or present in physically in the virtual environment. The restriction may also make a user uncomfortable or cause the user pain ultimately limiting the duration of a VR session.

VR headsets may be wireless. A wireless VR headset may avoid the restrictions associated with the above described VR headsets. Specifically, a wireless VR headset may include a wearable display and/or a computing device including a processing resource such as electronic circuitry to execute instructions stored on machine-readable medium to perform various operations. However, the wireless VR headset may not be tethered to a separate computing device, storage medium, wired data connection, power source, etc. The wireless VR headset may send and/or receive data, including data of an image or video stream to be displayed via the wearable display, wirelessly. For example, a wireless VR headset may send and/or receive data utilizing radio components for communicating data as radio frequency signals (e.g., WiFi, Bluetooth, NFC, WiMax, Zigbee, etc.) with a wireless data network.

Wireless data transmission may be restricted to an amount of bandwidth associated with a wireless data connection. Bandwidth may include the amount of data that can be carried across a wireless data connection and/or a data transfer rate associated with the wireless data connection. VR images and/or video streams may include a relatively large amount of data. That is delivering high quality VR video streams to a wireless VR headset may utilize a large portion of available bandwidth to deliver the information making up the VR video stream.

For example, a VR video may be captured utilizing 360-degree panorama camera consisting of sixteen outward facing camera capturing images in in 4K resolution, 30 frames per second and 24 bits per pixel using a 300:1 compression ratio. Such a video stream may consume 300 megabits per second to deliver the Imagery. This amount of data may far outstrip the bandwidth available for transmitting VR images and/or VR video streams to a wireless VR headset. By contrast, a wireless data connection may only be able to accommodate 25 megabits per second.

In another example, a high quality VR video stream may include information for providing images to two stereoscopic wearable displays at 4K resolution, 120 frames per second, and 24 bits per pixel using a 300:1 compression ratio. Such a stream may several Gigabits per second (Gbps) of bandwidth. These link speeds may not be presently achievable over wireless links.

In order to enable faster transmissions within available bandwidth, coder-decoder (codec) programs may be utilized to compress data at one endpoint of a wireless data connection for transmission and decompress the received data at another endpoint of the wireless data connection. However, there may be an amount of bandwidth associated with the codec. The bandwidth of a codec may include an amount of data and/or a data rate that a codec can process. That is, the amount of data, including VR images and/or VR video streams, that a codec can compress and/or decompress within a given time frame. Some compression of data may be lossless in that the compressed data retains all the information of the original uncompressed data. Other compression may be lossy in that the compressed data includes less than all of the information of the original uncompressed data. Lossy compression may result in a lower resolution image output than the original uncompressed image.

When there is more data to be delivered and/or decoded than there is bandwidth for doing so, the bottleneck may result in packet loss, delay in the VR video stream, latency in updating the VR video stream, frame jitter in the VR stream, and other artifacts that are noticeable to a user and will detract from the user experience. As used herein, latency may include when a movement detected by a wireless VR headset results in a corresponding shift in the image displayed on the wearable display, and the transition between the image is delayed and/or disrupted. Latency may result in a user losing a sense of being immersed in a virtual environment. In some examples, latency may provoke a sensation of motion sickness or loss of balance for a user.

A VR video stream to a VR headset may, in some examples, consume all of the bandwidth available for transmitting and/or decompressing VR video streams to the VR headset. However, during a portion of a VR video stream to a VR headset, the VR video stream may not consume all of the bandwidth available for transmitting and/or decompressing VR video streams to the VR headset.

Examples of the present disclosure may include a system that reduces latency associated with transitioning images displayed to a user as user movement is detected. The system may include a wearable display. The system may include instructions executable by a processor to assign a first portion of a total bandwidth, associated with wirelessly delivering a virtual reality VR video stream to the wearable display, to production of an image of an active region of the video stream on the wearable display. The system may also include instructions executable by a processor to assign a second portion of the total bandwidth to buffering a peripheral region of the video stream.

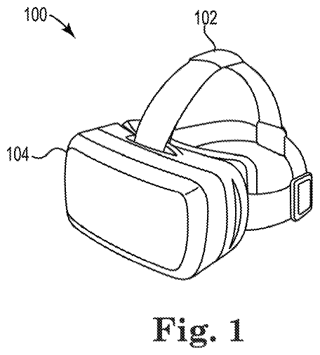

FIG. 1 illustrates an example of a system for virtual reality buffering consistent with the disclosure. The system may include a wireless device 102. The wireless device 102 may include a wireless virtual reality headset. The wireless device 102 may include a mounting portion. A mounting portion may include straps or other portions configured to contour to the head, face, or other portion of a user. The mounting portion may allow a user to utilize the wireless device 102 without having to hold the device in place over their eyes with their hands. That is, the mounting portion may suspend the wireless device 102 in position relative to the user by resting against and/or around the user. The mounting portion may be adjustable to a particular user's bodily dimensions.

The wireless device 102 may be configured to move with the user. That is, the wireless device 102 may not be fixed in a single place, but rather may be fixed to the user and free to move with the movement of the user. The wireless device 102 may not, during operation, utilize physical cabling to external power supplies, computing devices, memory resources, wired data connections, etc. Instead, the wireless device 102 may utilize radio communication to send and/or receive data wirelessly and may utilize an onboard power source during use.

The wireless device 102 may include a sensor. For example, the wireless device 102 may include a gyroscope, accelerometer, eye track sensors, structured light system, input devices, buttons, joysticks, pressure sensors, etc. for detecting user movement relative to the wireless device and/or relative to the user's physical environment.

The wireless device 102 may include a wearable display 104. The wearable display 104 may include a screen for displaying images to a user. The wearable display 104 may include more than one screen and/or more than one screen segment for displaying images to a user. The wearable display 104 may be wearable by a user. For example, the wearable display 104 may be held within a housing of the wireless device 102 during an operation of the wireless device 102. The wearable display 104 may display images to the user that are received wirelessly.

The wireless device 102 may include a computing device including a processing resource such as electronic circuitry to execute instructions stored on machine-readable medium to perform various operations. The wireless device 102 may include instructions executable by a processor to receive data making up a VR video stream. A VR video stream may include an image and/or video of images of a virtual environment. The VR video stream may include an image and/or video of images of a computer-generated simulation of the three-dimensional image or virtual environment that can be interacted with in a seemingly real or physical way by a person utilizing the wireless device 102. The wireless device 102 may include instructions executable by a processor to instantiate an interaction with and/or a navigation through a virtual environment on the wearable display 104 by modifying the particular image, portion of the image, portion of the video, etc. being displayed on the wearable display 104. The modification to the image instantiated on the wearable display 104 may correspond to an update to a region of the virtual environment that is visible to the user. The region of the virtual environment visible to the user may be determined by the position of the user and/or a change in the position of the user detected by the sensor. The position and/or change of position of the user may be translated to a corresponding virtual position and/or movement and a new virtual view associated with the corresponding position.

The wearable display 104 may display an active region of the VR video stream. As used herein, an active region of the VR video stream may include a portion of an image and/or a video of a virtual environment that is virtually and physically visible to the user of the wireless device 102. The active region may include the portion of the image and/or video of the virtual environment that fits on the wearable display 104 and is visible to the user.

The VR video stream may also include non-active regions. For example, less than all of the entire virtual image and/or video of the virtual environment may be visible to the user at a given point in time. Analogous to actual reality, virtual reality environments may contain more information than is visible to the human eye at a particular time and in a particular position. Therefore, a virtual environment and the images/videos thereof may include more information than is displayed on the wearable display at a particular moment in time. That is, there are portions of the virtual environment that are not within the virtual field of view of a virtual environment from a virtual position within the virtual environment at a particular moment in time. Consequently, those portions of the virtual environment not within the virtual field of view are not actually visible and/or displayed to the user. The data for those other portions of the virtual environment (e.g., the data for instantiating an image and/or video of the non-viewed portions of the virtual environment on the wearable display 104) exists despite not being actively used to instantiate an image on the wearable display 104 just as objects outside a human's field of view exist despite not being actively viewed. The non-active regions of a VR video stream may include the regions of an image and/or video of a virtual environment and/or the information associated therewith that are part of the virtual environment that a user is interacting with but are not the regions that are actively visible to the user on the wearable display 104.

Portions of the non-active regions may include peripheral regions. Peripheral regions may include regions of image and/or video of the virtual environment that are adjacent to, and in some examples directly abutting, the active region. That is, the peripheral regions may include information for instantiating, on the wearable display 104, the portion of the virtual environment that is adjacent to the portion that is actively displayed on the wearable display 104.

The wireless device 102 may include instructions executable by a processor to decode the data for instantiating an active region of a VR video stream on the wearable display 104. The wireless device 102 may utilize a codec to decode the data for instantiating an active region of a VR video stream on the wearable display 104.

The wireless device 102 may include instructions executable by a processor to instantiate the image and/or video of a portion of the virtual environment on the wearable display 104. That is, the wireless device 102 may include instructions executable by a processor to display the wirelessly received and/or decoded portion of the VR video stream on the wearable display 104. The portion of the VR video stream instantiated on the wearable display 104 may be the active region of the VR video stream.

The wireless device 102 may include a buffer. The buffer may be a portion of machine-readable memory reserved for storing information. The buffer may be a portion of machine-readable memory that may store wirelessly received information for instantiating an image and/or video of a virtual environment. The buffer may be a portion of machine-readable memory that may store wirelessly received information for instantiating a non-active region of an image and/or video of the virtual environment. For example, the buffer may be a portion of machine-readable memory that may store wirelessly received information for instantiating a peripheral region of an image and/or video of the virtual environment.

Buffering such information local to the wireless device 102 rather than newly retrieving the information wirelessly may result in a reduced amount of packet loss, delay in the VR video stream, latency in updating the VR video stream, frame jitter in the VR stream, and other artifacts when transitioning between displaying a portion of the active region and a portion of a peripheral region. That is, buffering peripheral regions of the image and/or video of the virtual environment locally on the wireless device 102 allows for retrieval, rendering, and/or instantiation of the peripheral region on the wearable display 104 more rapidly and with a smoother and more realistic appearance than doing so over the wireless connection responsive to detecting the precipitating user movement and/or a contemporaneous with a command to display the peripheral region on the wearable display 104. Additionally, having the peripheral region buffered allows the wireless device to conserve total bandwidth associated with wirelessly delivering a VR video stream to the wearable display 104. That is, being able to retrieve the image and/or video of the peripheral region of the virtual environment from a local buffer may avoid consuming available bandwidth for wireless delivering the data to the wireless device 102 and/or consuming available bandwidth for coding and/or decoding the image and/or video of the virtual environment.

The wireless device 102 may include instructions executable by a processor to identify and/or monitor a total bandwidth available to wirelessly deliver a virtual reality (VR) video stream to the wearable display. The wireless device 102 may identify and/or monitor a total amount of bandwidth available to wirelessly transmit images and/or videos of the virtual environment between a source and the wireless device 102. Additionally, the wireless device 102 may identify and/or monitor a total amount of bandwidth available to code and/or decode images and/or videos of the virtual environment wirelessly transmitted between a source and the wireless device 102. The wireless device 102 may periodically or continuously identify and/or monitor the total available bandwidth throughout a presentation of a VR video stream on the wearable display 104.

The wireless device 102 may include instructions executable by a processor to partition the total bandwidth. For example, the wireless device 102 may include instructions executable by a processor to assign a first portion of a total bandwidth to an instantiation of an image and/or video of an active region of a VR video stream on the wearable display 104. Assigning the first portion of the total bandwidth may include reserving the first portion of a bandwidth available for wireless communicating data between a source and the wireless device 102 for a use limited to wirelessly communicating the active region of the VR video stream. Additionally, or alternatively, assigning the first portion of the total bandwidth may include reserving the first portion of a codec bandwidth available for coding and/or decoding data wirelessly communicated between the source and the wireless device 102 for a use limited to coding and/or decoding the active region of the VR video stream.

The wireless device 102 may include instructions executable by a processor to assign a second portion of the total bandwidth to be utilized to buffer data defining an image and/or video of a peripheral region of the VR video stream. That is, a second portion of the total bandwidth may be assigned to wirelessly communicate, code, and/or decode data defining a non-displayed image and/or video of a region of the VR video stream peripheral to the active region without instantiating the image and/or video of a region of the VR video stream on the wearable display 104. Assigning the second portion of the total bandwidth may include reserving the second portion of a bandwidth available for wireless communicating data between a source and the wireless device 102 for a use limited to wirelessly communicating the peripheral region of the VR video stream for storage to and/or retrieval from a buffer local to the wireless device 102. Additionally, or alternatively, assigning the second portion of the total bandwidth may include reserving the second portion of a codec bandwidth available for coding and/or decoding data wirelessly communicated between the source and the wireless device 102 for a use limited to coding and/or decoding the peripheral region of the VR video stream for storage to and/or retrieval from a buffer local to the wireless device 102.

The first portion of the total bandwidth assigned to the instantiation of the image of the active region of the video stream on the wearable display 104 and/or the second portion of the total bandwidth assigned to the buffering of the peripheral region of the video stream may be a static amount throughout the display of the VR video stream. In other examples, one or both of the first portion and the second portion may be variable amounts. For example, the first portion and the second portion may be amounts that fluctuate with fluctuations in total available bandwidth. In another example, the first portion and the second portion may be amounts that fluctuate in response to a fluctuation of one another.

For example, the first portion of a total bandwidth assigned to an instantiate an image of an active region of the video stream on the wearable display 104 may be determined based on an amount of data associated with a portion of the VR stream corresponding to the active region. That is, the first portion of total bandwidth assigned to the wireless communicating, coding, decoding, and/or rendering of the active region may be determined to be the portion of total bandwidth involved to accommodate the entirety of the data to instantiate the active region on the wearable display 104 at full quality (e.g., a targeted frame rate, targeted bits per pixel, targeted compression ratio, targeted resolution, etc.) determined by the source of the active region data. In other words, instantiation of the active region may be assigned a first portion of bandwidth corresponding to all of the bandwidth that it will consume in communicating, coding, decoding, and/or rendering the image and/or video of the active region at its intended quality. In some examples, this first portion may be a static amount of bandwidth throughout the display of the VR video stream. In some examples, the first portion may be a variable amount of bandwidth that fluctuates with changes in the data and/or intended quality level of an active region. The portion and/or amount of the total bandwidth remaining after that assignment of the first portion of the total bandwidth may, by default, make up the second portion of the total bandwidth. In this manner, the second portion of the total bandwidth assigned to buffering the peripheral region may be variable as it may be determined based on an amount of the total bandwidth remaining after the assignment of the first portion of the total bandwidth.

However, in some examples the first portion assigned to instantiate an image of an active region of the video stream on the wearable display 104 may be less than an amount of total bandwidth to accommodate the entirety of the data to instantiate the active region on the wearable display 104 at a quality determined by the source of the active region data. In such examples, the wireless device 102 may include Instructions executable by a processor to exclude data defining the image and/or video of the active region instantiated on the wearable display 104 when an amount of data associated with instantiating the image exceeds an amount of information deliverable utilizing the assigned first portion of the total bandwidth. In other words, data may be lost, dropped, or otherwise degraded in order to remain within the assigned limits of the first portion of total bandwidth.

For example, as described above the first portion of total bandwidth may be an amount and/or portion of a total bandwidth that remains static through the display of the VR video stream. In such an example, there may be moments throughout the VR video stream where the assigned first portion of the total bandwidth accommodates the entirety of the data to instantiate the active region on the wearable display 104 at a quality determined by the source of the active region data. However, there may be moments throughout the VR video stream where the assigned first portion of the total bandwidth cannot accommodate the entirety of the data to instantiate the active region on the wearable display 104 at a quality determined by the source of the active region data. In another example, the total available bandwidth may fluctuate, resulting in the total available bandwidth and/or the first portion of the total available bandwidth dropping below an amount of bandwidth involved in accommodating the entirety of the data to instantiate the active region on the wearable display 104 at a quality determined by the source of the active region data.

In another example, the amount of the first portion of the total bandwidth and the amount of the second portion of the total bandwidth may be variable throughout the course of a VR video stream. For example, the amount of the first portion of the total bandwidth and the amount of the second portion of the total bandwidth may be determined based on a predicted shift of the active region into the peripheral region for the VR video stream. That is, the amount of the first portion of total bandwidth assigned to the wireless communicating, coding, decoding, and/or rendering of the active region and the amount of the second portion of total bandwidth assigned to buffer a peripheral region of the video stream may vary at different moments throughout the VR video stream based on a predicted movement of the user and/or a predicted shift of the image and/or video instantiated on the wearable display 104 away from a portion of the active region and to a portion of the peripheral region.

For example, the amount of the first portion of total bandwidth assigned to the wireless communicating, coding, decoding, and/or rendering of the active region may be decreased and the amount of the second portion of total bandwidth assigned to buffer a peripheral region of the video stream may be increased based on a prediction that the image and/or video instantiated on the wearable display 104 will be changed from the active region to a peripheral region.

The prediction may be based on historical data of the user's previous interactions with the VR video stream and/or the virtual environment depicted therein. Specifically, the wireless device 102 may include instructions executable by a processor to monitor and/or record a user's movements and/or the corresponding regions of the virtual environment depicted in the VR video stream that are present on the wearable display 104 from moment to moment during the VR video stream. In this manner, the wireless device 102 may determine regions of the virtual environment that a user has historically viewed, caused to be instantiated on the wearable display 104, and/or interacted with in past iterations of the VR stream and may predict that a user is likely to repeat this behavior in future iterations of the VR streams.

Additionally, the wireless device 102 may determine regions of the virtual environment that a user has historically viewed, caused to be instantiated on the wearable display 104, and/or interacted with in past iterations of the VR stream and may predict that a user is likely to view, cause to be instantiated, and/or interact with a different region of the virtual environment in future iterations of the VR streams. As such, the wireless device 102 may include instructions executable by a processor to throttle the amount of bandwidth provided to wireless communicate, code, decode, and/or render the active region and the amount of bandwidth provided to buffer a peripheral region based on these predictions. For example, if a peripheral region is above a threshold amount of likelihood to be shifted to for instantiation on the wearable display 104 during a period of the VR video stream then the amount of total bandwidth assigned to the first portion may be decreased and the amount of the total bandwidth assigned to the second portion may be increased during that period.

In addition to basing the above described VR environment region prediction on historical data of the user's previous interactions with the VR video stream and/or the virtual environment depicted therein, the prediction may be based on historical data of other user's previous interactions with the VR video stream and/or the virtual environment depicted therein. Further, the prediction may be based on queues present in peripheral regions of the virtual environment that are present to attract a user's attention. For example, if a peripheral region of the VR video stream includes an image and/or video that a user is intended to interact with, the wireless device 102 may include instructions executable by a processor to momentarily decrease the amount of bandwidth provided to wireless communicate, code, decode, and/or render the active region and momentarily increase the amount of bandwidth provided to buffer the queue containing peripheral region.

The amount of the total bandwidth assigned to the first portion and the second portion may be limits. That is, a wireless data communication, coding operation, decoding operation, rendering operation, or buffering operation that would exceed its respective assigned portion of total bandwidth may be throttled, inhibited, and/or prevented by the wireless device 102. For example, an amount of data associated with instantiating an image of the active region on the wearable display 104 may exceed an amount of information deliverable utilizing the assigned first portion of the total bandwidth. For example, the instantiation of the image of the active region of the VR video stream may be assigned eighty percent and/or eight gigabits per second portion of a ten gigabits per second total bandwidth. If wirelessly communicating, coding, decoding, and/or rendering the active region at a full quality (e.g., a targeted frame rate, targeted bits per pixel, targeted compression ratio, targeted resolution, etc.) would consume nine gigabits per second of total bandwidth, then data of the image and/or video of the active region may be excluded. For example, packets may be dropped and/or a lossy compression technique may be implemented. The result of such an exclusion of data may be a degradation of the appearance and/or quality of the image and/or video to the user as compared to the source image and/or video.

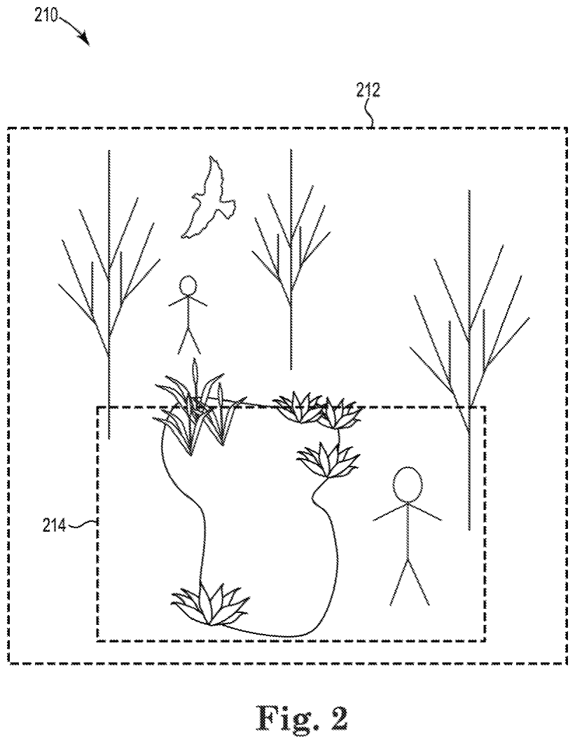

FIG. 2 illustrates an example of a virtual environment 210 for virtual reality buffering consistent with the disclosure. The virtual environment 210 may include instructions stored on machine-readable medium including data to instantiate a graphical representation of the virtual environment 210 on a wearable display. That is, the virtual environment 210 may be a graphical computer model of an environment. As described throughout, less than all of the virtual environment may be instantiated on the wearable display at any given moment throughout a presentation of a VR video stream to a user of a wireless VR headset.

The virtual environment 210 may include an active region 214. An active region 214 may include the region of the virtual environment 210 and/or the corresponding representational data of that region that is actively being displayed on the wearable display a particular moment in a VR video stream of the virtual environment 210. The active region 214 may be determined based on where a user of a wireless VR headset is virtually looking within the virtual environment 210, which, in turn, is determined based on a physical position or physical movement of a user of the wireless VR headset.

The virtual environment 210 may include a peripheral region 212. The peripheral region 212 may include a region of the virtual environment 210 and/or the corresponding representational data of that region that is not actively being displayed on the wearable display a particular moment in a VR video stream of the virtual environment 210. The peripheral region 212 may include the remainder of the virtual environment 210 excluding the active region 214. Alternatively, the peripheral region 212 may include less than the entire remainder of the virtual environment 210 excluding the active region 214. Although not illustrated in FIG. 2, the virtual environment 210 may include a plurality of peripheral regions 212.

The active region 214 may be assigned a first portion of a total bandwidth available for wireless data communication, coding operations, decoding operations, rendering operations, buffering operations, etc. between a source of the virtual environment 210 and a wireless VR headset displaying the image and/or video of a VR video stream of the virtual environment 210. In some examples, a larger portion of a total bandwidth may be reserved for and/or assigned to wireless communicating, coding, decoding, and/or rendering of the active region 214 than the peripheral region 212. The peripheral region 212 may be assigned a second portion of the total bandwidth to buffer the peripheral region 212 to a storage location local to the wireless VR headset.

In an example, the first portion and the second portion assignments of the total bandwidth may be static. For example, wirelessly communicating, coding, decoding, and rendering the active region 214 may be assigned eighty percent and/or eight gigabits per second of a ten gigabit per second total available bandwidth throughout a portion of the VR video stream to a wireless VR headset. During the same portion of the VR video stream to the wireless VR headset, buffering of the peripheral region 212 may be assigned twenty percent and/or two gigabits per second of the ten gigabit per second total available bandwidth between the wireless VR headset and the source of the virtual environment 210. The amount of the total bandwidth assigned to the active region 214 and the peripheral region 212 may be determined based on an amount of expected shift of the image displayed on the wearable display of the wireless VR headset from an active region 214 to a peripheral region 212. The amount of expected shift may be predicted based on historical data of a prior active region shift into the peripheral region during a prior delivery of the same VR video stream and/or design features (e.g., checkpoints, visual cues, audio cues, points of interest, etc.) of the virtual environment 210.

In some examples, the first portion and the second portion assignments of the total bandwidth may be variable throughout the delivery of the VR video stream to the wireless VR headset. For example, the active region 214 may be given priority over the total available bandwidth. The priority may be an assignment of a static amount of the total available bandwidth that does not vary with fluctuations in the total available bandwidth. For example, wirelessly communicating, coding, decoding, and rendering the active region 214 may be assigned six gigabits per second of the total available bandwidth and that amount may not vary whether the total available bandwidth is ten gigabits per second or whether the total available bandwidth has fluctuated down to six gigabits per second. In such an example, the amount of the total bandwidth assigned to buffering the peripheral region 212 may fluctuate based on fluctuations in the total available bandwidth. For example, the amount of the total bandwidth assigned to buffering the peripheral region 212 may be determined based on the amount of total available bandwidth remaining after subtraction of the first portion of total bandwidth assigned to the active region 214 from the total available bandwidth at a given moment of the delivery and/or display of the VR video stream to the wireless VR headset.

In another example, the active region 214 may be given priority over the total available bandwidth by assigning wirelessly communicating, coding, decoding, and rendering the active region 214 carte blanche access to the total available bandwidth. For example, the active region 214 may be permitted to consume as much of the total available bandwidth, up to one hundred percent, to wirelessly communicate, code, decode, and/or render an image and/or video of the active region 214 on the wearable display of the wireless VR headset at a full quality. Therefore, the amount of the first portion of total available bandwidth assigned to wirelessly communicate, code, decode, and/or render an image and/or video of the active region 214 may be variable, but its priority may not vary. In such examples, the amount of the total bandwidth assigned to buffering the peripheral region 212 may be variable and be determined based on the amount of total available bandwidth remaining after subtraction of the first portion of total bandwidth assigned to the active region 214 from the total available bandwidth at a given moment of the delivery and/or display of the VR video stream to the wireless VR headset.

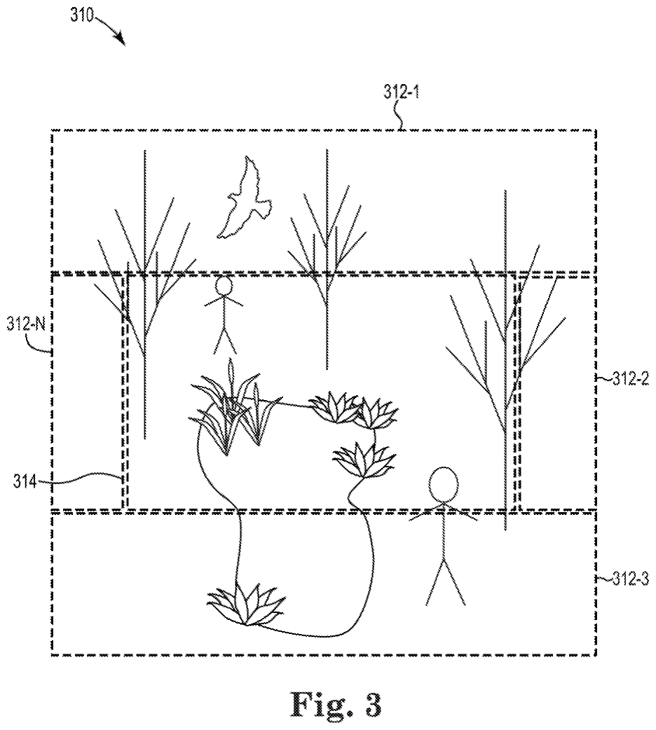

FIG. 3 illustrates an example of a virtual environment 310 for virtual reality buffering consistent with the disclosure. The virtual environment 310 may include an active region 314. An active region 314 may include the region of the virtual environment 310 and/or the corresponding representational data of that region that is actively being displayed on the wearable display a particular moment in a VR video stream of the virtual environment 310. The active region 314 may be determined based on where a user of a wireless VR headset is virtually looking within the virtual environment 310, which, in turn, is determined based on a physical position or physical movement of a user of the wireless VR headset.

The virtual environment 310 may include a plurality of peripheral regions 312-1 . . . 312-N. The peripheral regions 312-1 . . . 312-N may include portions of the virtual environment 310 and/or the corresponding representational data of those portions that are not actively being displayed on the wearable display a particular moment in a VR video stream of the virtual environment 310. The peripheral regions 312-1 . . . 312-N may include the remainder of the virtual environment 310 excluding the active region 314. Alternatively, the peripheral regions 312-1 . . . 312-N may include less than the entire remainder of the virtual environment 310 excluding the active region 314.

A first portion of a total available bandwidth may be assigned to be dedicated to the production of an image of the active region 314 of the VR video stream on a wearable display of the wireless VR device. A second portion of the total available bandwidth may be assigned to buffering, on a wireless VR headset, a first peripheral region of the plurality of peripheral regions 312-1 . . . 312-N. A third portion of the total available bandwidth may be assigned to buffering, on the wireless VR headset, second peripheral region of the plurality of peripheral regions 312-1 . . . 312-N.

Similar to the details described above, wirelessly communicating, coding, decoding, and/or rendering the active region 314 may be assigned a static first portion of the total bandwidth, assigned a variable first portion of the total bandwidth, and/or granted priority over the peripheral regions 312-1 . . . 312-N with regard to the total available bandwidth. Similar to the details described above, buffering of the peripheral regions 312-1 . . . 312-N may be assigned the remaining total available bandwidth after the first portion is subtracted therefrom.

Additionally, buffering of the various peripheral regions 312-1 . . . 312-N may include granting particular peripheral regions of the plurality of peripheral regions 312-1 . . . 312-N priority over and/or a greater amount of a total available bandwidth remaining after subtracting the first portion of total bandwidth assigned to the production of the image and/or video of the active region 314. For example, the peripheral regions 312-1 . . . 312-N may be characterized and/or identified by their spatial relationship in the virtual environment 310 in relation to the active region 314. In a specific example, the peripheral regions 312-1 . . . 312-N may be characterized and/or identified by their spatial relationship in the virtual environment 310 in relation to an x-axis (e.g., horizontal plane) and/or a y-axis (e.g., vertical plane) of the active region 314. For example, peripheral regions 312-2 and 312-N may be characterized and/or identified as x-axis peripheral regions lying along and/or within a horizontal plane adjacent to the active region 314 within the virtual environment 310. In another example, the peripheral regions 312-1 . . . 312-3 may be characterized and/or identified as y-axis peripheral regions lying along and/or within a vertical plane adjacent to the active region 314 within the virtual environment 310.

The amount of total available bandwidth, minus the first portion assigned to wirelessly communicating, coding, decoding, and rendering the active region 314, may be assigned to the various peripheral regions 312-1 . . . 312-N based on their corresponding characterization and/or identification described above. In a specific example, the x-axis peripheral regions 312-2 and 312-N may be each be assigned forty percent of the remaining total available bandwidth (e.g., the total available bandwidth minus the assigned first portion of bandwidth). Meanwhile, the y-axis peripheral regions 312-1 and 312-3 may each be assigned ten percent of the remaining total available bandwidth. In this manner, the x-axis peripheral regions 312-2 and 312-N may have a higher priority over the total available bandwidth than the y-axis peripheral regions 312-1 and 312-3 since more of the remaining total bandwidth is reserved for buffering the x-axis peripheral regions 312-2 and 312-N.

The allocation of the remaining total bandwidth to be assigned among the various peripheral regions 312-1 . . . 312-N may be determined based on historical data indicating the prevalence of a shift from an active region 314 to a peripheral region 312-1 . . . 312-N lying along and/or within a plane relative to the active region 314. For example, either statically or in substantially real time, a determination may be made that when a user views a VR video stream they primarily tend to shift the region of the virtual environment that they are viewing in a wearable display horizontally along an x-axis. Based on this determination, more of the remaining bandwidth may be reserved for buffering the peripheral regions along and/or within the horizontal axis, in this example x-axis peripheral regions 312-2 and 312-N, than for buffering the peripheral regions along and/or within a vertical axis, in this example y-axis peripheral regions 312-1 and 312-3.

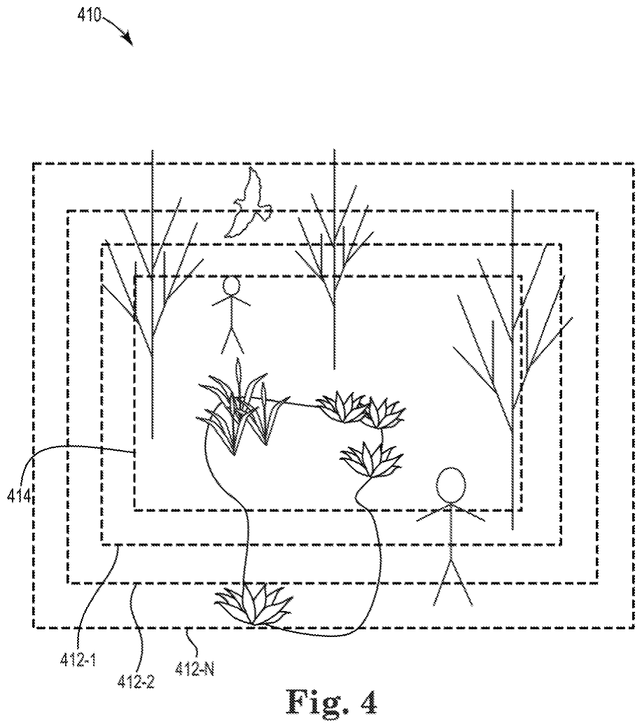

FIG. 4 illustrates an example of a virtual environment 410 for virtual reality buffering consistent with the disclosure. The virtual environment 410 may include an active region 414. An active region 414 may include the region of the virtual environment 410 and/or the corresponding representational data of that region that is actively being displayed on a wearable display at a particular moment in a VR video stream of the virtual environment 410. The active region 414 may be determined based on where a user of a wireless VR headset is virtually looking within the virtual environment 410, which, in turn, is determined based on a physical position or physical movement of a user of the wireless VR headset.

The virtual environment 410 may include a plurality of peripheral regions 412-1 . . . 412-N. The peripheral regions 412-1 . . . 412-N may include portions of the virtual environment 410 and/or the corresponding representational data of those portions that are not actively being displayed on the wearable display a particular moment in a VR video stream of the virtual environment 410. The peripheral regions 412-1 . . . 412-N may include the remainder of the virtual environment 410 excluding the active region 414. Alternatively, the peripheral regions 412-1 . . . 412-N may include less than the entire remainder of the virtual environment 410 excluding the active region 414.

As described above, the first portion of a total available bandwidth may be assigned to be dedicated to the production of an image of the active region 414 of the VR video stream on a wearable display of the wireless VR device. A second portion of the total available bandwidth may be assigned to buffering, on a wireless VR headset, a first peripheral region of the plurality of peripheral regions 412-1 . . . 412-N. A third portion of the total available bandwidth may be assigned to buffering, on the wireless VR headset, second peripheral region of the plurality of peripheral regions 412-1 . . . 412-N.

Similar to the details described above, wirelessly communicating, coding, decoding, and/or rendering the active region 414 may be assigned a static first portion of the total bandwidth, assigned a variable first portion of the total bandwidth, and/or granted priority over the peripheral regions 412-1 . . . 412-N with regard to the total available bandwidth. Similar to the details described above, buffering of the peripheral regions 412-1 . . . 412-N may be assigned the remaining total available bandwidth after the first portion is subtracted therefrom.

Additionally, buffering of the various peripheral regions 412-1 . . . 412-N may include granting particular peripheral regions of the plurality of peripheral regions 412-1 . . . 412-N priority over and/or a greater amount of a total available bandwidth remaining after subtracting the first portion of total bandwidth assigned to the production of the image and/or video of the active region 414. For example, the peripheral regions 412-1 . . . 412-N may be characterized and/or identified by their spatial relationship in the virtual environment 410 in relation to the active region 414. In a specific example, the peripheral regions 412-1 . . . 412-N may be characterized and/or identified as regions of the virtual environment 410 defined by concentric boundaries adjacent to and/or surrounding the active region 414. For example, the peripheral region 412-1 may be characterized and/or identified as a first concentric peripheral region immediately adjacent to and surrounding the active region 414. The peripheral region 412-2 may be characterized and/or identified as a second peripheral concentric region immediately adjacent to and surrounding the first concentric peripheral region 412-1. The peripheral region 412-N may be characterized and/or identified as a third concentric peripheral region immediately adjacent to and surrounding the second concentric peripheral region 412-2. Each of the concentric peripheral regions 412-1 . . . 412-N may include a portion of the VR environment 410 that surrounds the active region 414 but includes portions of the VR environment that are further from the active region 414 with each additional concentric peripheral region characterized and/or identified.

The amount of total available bandwidth, minus the first portion assigned to wirelessly communicating, coding, decoding, and rendering the active region 414, may be assigned to the various peripheral regions 412-1 . . . 412-N based on their corresponding characterization and/or identification described above. In a specific example, the first concentric peripheral region 412-1 may be assigned sixty-five percent of the remaining total available bandwidth (e.g., the total available bandwidth minus the assigned first portion of bandwidth). Meanwhile, the second concentric peripheral region 412-2 may be assigned twenty-five percent of the remaining total available bandwidth. The third concentric peripheral region 412-N may be assigned ten percent of the remaining total available bandwidth. In this manner, the first concentric peripheral region 412-1 may have a higher priority over the total available bandwidth than the second and third concentric peripheral regions 412-2 and 412-N since more of the remaining total bandwidth is reserved for buffering the first concentric peripheral region 412-1. Such an allocation of the remaining total bandwidth among the various peripheral regions 412-1 . . . 412-N may allow for buffering the portions of the virtual environment 410 that are closer to the active region 414 to buffer first and/or at a higher rate than the more distant portions. Such examples may be implemented in VR video streams that frequently elicit small, relative to the VR environment, shifts from the active region 414 to peripheral regions along and/or within a horizontal and/or a vertical plane that are close to the active region 414.

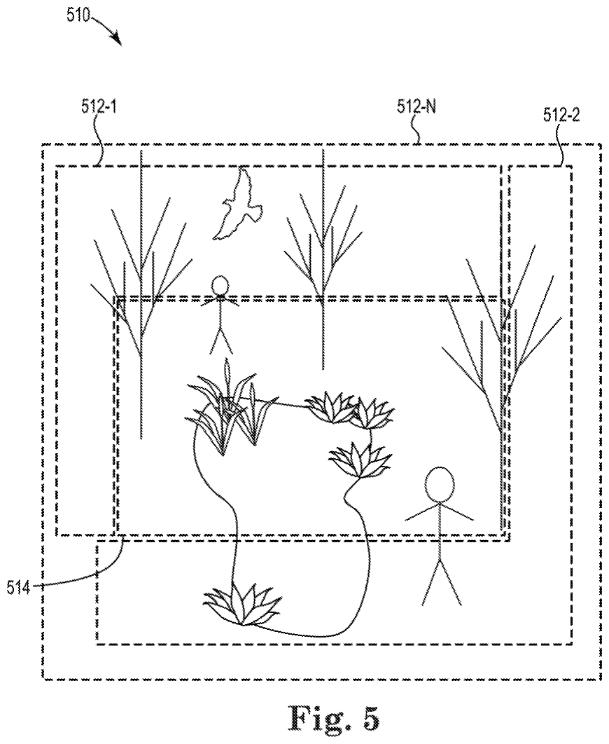

FIG. 5 illustrates an example of a virtual environment 510 consistent with the disclosure. The virtual environment 510 may include an active region 514. An active region 514 may include the region of the virtual environment 510 and/or the corresponding representational data of that region that is actively being displayed on a wearable display at a particular moment in a VR video stream of the virtual environment 510. The active region 514 may be determined based on where a user of a wireless VR headset is virtually looking within the virtual environment 510, which, in turn, is determined based on a physical position or physical movement of a user of the wireless VR headset.

The virtual environment 510 may include a plurality of peripheral regions 512-1 . . . 512-N. The peripheral regions 512-1 . . . 512-N may include portions of the virtual environment 510 and/or the corresponding representational data of those portions that are not actively being displayed on the wearable display a particular moment in a VR video stream of the virtual environment 510. The peripheral regions 512-1 . . . 512-N may include the remainder of the virtual environment 510 excluding the active region 514. Alternatively, the peripheral regions 512-1 . . . 512-N may include less than the entire remainder of the virtual environment 510 excluding the active region 514.

As described above, the first portion of a total available bandwidth may be assigned to be dedicated to the production of an image of the active region 514 of the VR video stream on a wearable display of the wireless VR device. A second portion of the total available bandwidth may be assigned to buffering, on a wireless VR headset, a first peripheral region of the plurality of peripheral regions 512-1 . . . 512-N. A third portion of the total available bandwidth may be assigned to buffering, on the wireless VR headset, second peripheral region of the plurality of peripheral regions 512-1 . . . 512-N.

Similar to the details described above, wirelessly communicating, coding, decoding, and/or rendering the active region 514 may be assigned a static first portion of the total bandwidth, assigned a variable first portion of the total bandwidth, and/or granted priority over the peripheral regions 512-1 . . . 512-N with regard to the total available bandwidth. Similar to the details described above, buffering of the peripheral regions 512-1 . . . 512-N may be assigned the remaining total available bandwidth after the first portion is subtracted therefrom.

Additionally, buffering of the various peripheral regions 512-1 . . . 512-N may include granting particular peripheral regions of the plurality of peripheral regions 512-1 . . . 512-N priority over and/or a greater amount of a total available bandwidth remaining after subtracting the first portion of total bandwidth assigned to the production of the image and/or video of the active region 514. For example, the peripheral regions 512-1 . . . 512-N may be characterized and/or identified by their spatial relationship in the virtual environment 510 in relation to the active region 514. In a specific example, the peripheral regions 512-1 . . . 512-N may be characterized and/or identified as regions of the virtual environment 510 corresponding to regions outside of the active region 514 that were, in previous displays of the VR stream, displayed on the wearable display. In this manner, regions of the virtual environment that are most likely to be viewed again may be characterized and identified. For example, a first peripheral region 512-1 may be characterized and/or identified based on the region having been viewed seven out of the last ten times the VR video stream of the VR environment 510 was displayed. The second peripheral region 512-2 may be characterized and/or identified based on the region having been viewed two out of the last ten times the VR video stream of the VR environment 510 was displayed. The third peripheral region 512-N may be characterized and/or identified based on the region having been viewed one out of the last ten times that the VR video stream of the VR environment 510 was displayed.

The amount of total available bandwidth, minus the first portion assigned to wirelessly communicating, coding, decoding, and rendering the active region 514, may be assigned to buffering of the various peripheral regions 512-1 . . . 512-N based on their corresponding characterization and/or identification described above. In a specific example, the first peripheral region 512-1 may be assigned seventy percent of the remaining total available bandwidth (e.g., the total available bandwidth minus the assigned first portion of bandwidth). Meanwhile, the second peripheral region 512-2 may be assigned twenty percent of the remaining total available bandwidth. The third peripheral region 512-N may be assigned ten percent of the remaining total available bandwidth. In this manner, the first peripheral region 512-1 may have a higher priority over the total available bandwidth than the second and third peripheral regions 512-2 and 512-N since more of the remaining total bandwidth is reserved for buffering the first peripheral region 512-1. Such an allocation of the remaining total bandwidth among the various peripheral regions 512-1 . . . 512-N may allow for buffering the portions of the virtual environment 510 that are more likely to be viewed to buffer first and/or at a higher rate than less likely portions. For example, for a portion of a VR video stream where a user frequently shifts the region being viewed from the active region 514 to the upper and left quadrant of the virtual environment 510, the above described allocation may provide a highest likelihood of having a shifted to peripheral region already buffered on the wireless VR headset.

The various examples of allocating, prioritizing, and/or assigning bandwidth between active regions and/or a peripheral region described in FIGS. 2-5 may be transitioned between during a session of utilizing a VR video stream. A schedule of utilizing the various methods for allocating, prioritizing, and/or assigning bandwidth between active regions and/or a peripheral region may be static throughout a session of utilizing a VR video stream and/or predetermined. Alternatively, the various methods for allocating, prioritizing, and/or assigning bandwidth between active regions and/or a peripheral region may be transitioned between based on substantially real time analysis of feedback data regarding the utilization of the VR video stream.

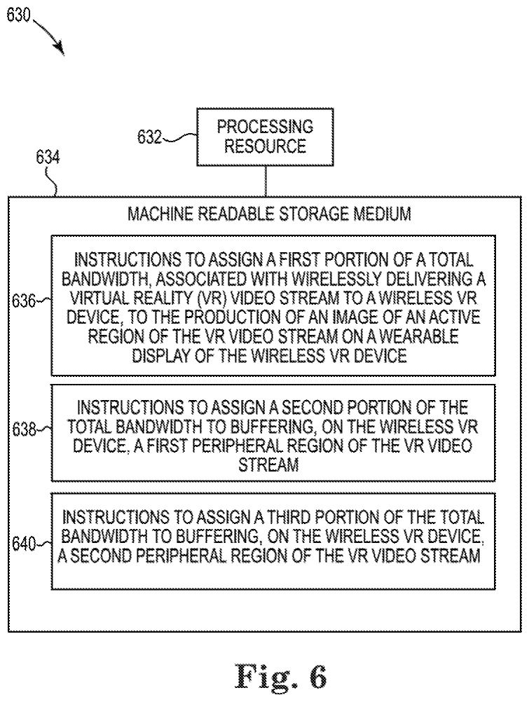

FIG. 6 illustrates a diagram 630 of an example of a processing resource 632 and a non-transitory machine readable storage medium 634 for virtual reality buffering consistent with the disclosure. A memory resource, such as the non-transitory machine readable medium 634, may be used to store instructions (e.g., 636, 638, 640) executed by the processing resource 632 to perform the operations as described herein. A processing resource 632 may execute the instructions stored on the non-transitory machine readable medium 634. The non-transitory machine readable medium 634 may be any type of volatile or non-volatile memory or storage, such as random access memory (RAM), flash memory, read-only memory (ROM), storage volumes, a hard disk, or a combination thereof.

The example medium 634 may store instructions 636 executable by the processing resource 632 to assign a first portion of a total bandwidth to be utilized in the production of an image of an active region of a VR video stream on a wearable display of the wireless VR device. The total bandwidth may be a total available bandwidth for wireless data communication, coding, decoding, rendering, displaying, and/or buffering data between a source of A VR video stream and a wireless VR device. The active region of the VR video stream may be the portion of a VR environment that a viewer is directing, by virtue of their physical positioning, to be displayed on the wearable display of the wireless VR device.

The example medium 634 may store instructions 638 executable by the processing resource 632 to assign a second portion of the total bandwidth to be utilized in buffering, on the wireless device, a first peripheral region of the VR video stream. The peripheral region of the VR video stream may be a portion of the VR environment that is adjacent to but outside of the active region. Buffering the peripheral region of the VR stream may include storing the data for displaying the peripheral region in a buffer and/or cache located on the wireless VR device. The buffered data may be retrieved locally from the buffer and/or cache to cause a buffered peripheral region to be displayed on the wearable display responsive to a detected user movement changing a user's virtual view of the VR video stream.

The example medium 634 may store instructions 640 executable by the processing resource 832 to assign a third portion of the total bandwidth to buffering, on the wireless VR device, a second peripheral region of the VR video stream.

In an example, the first peripheral region may correspond to a non-displayed portion of the VR video stream. The first peripheral region may be a portion of the VR stream that is capable of being displayed on a wearable display, but is not being displayed at the moment of identification. That is, the first peripheral region may be a region of a virtual environment that exists in a computer model, but is not being virtually looked at by the user and is therefore not being displayed on a wearable display during a utilization of VR video stream. The first peripheral region may be a portion of the VR video stream and/or a virtual environment that is adjacent to the active region. For example, the first peripheral region may be in contact with and/or have a boundary defined by a boundary of the active region and may encompass a portion of the VR video stream outside of the active region. The first peripheral region may be adjacent to the active region along a first axis. For example, the first peripheral region may be located adjacent to the active region along and/or within a horizontal plane or x-axis relative to the active region.

The second peripheral region may be a non-displayed portion of the VR video stream. The second peripheral region may be adjacent to the active region. The second peripheral region may be adjacent to the active region along a second axis perpendicular to the first axis. For example, the second peripheral region may be located adjacent to the active region along and/or within a vertical plane or y-axis relative to the active region.

The amount of the second and third portion of total bandwidth may be determined based on predicted changes in the portion of the VR video stream that will be displayed on the wearable display of the wireless VR device throughout the utilization of the VR video stream. For example, the amount of the second portion of total bandwidth reserved for buffering the first peripheral region located adjacent to the active region along and/or within a horizontal plane or x-axis relative to the active region may be a greater amount than the amount of the third portion of the total bandwidth reserved for buffering the second peripheral region located adjacent to the active region along and/or within a vertical plane or y-axis relative to the active region. This example assignment of total bandwidth may result from a determination that in previous utilizations of the VR video stream and/or in previous portions of the current utilization of the VR video stream, the user most commonly causes changed in the portion of the VR video stream being displayed to regions along and/or within a horizontal plane or x-axis relative to the active region. As such, the peripheral regions of the VR video stream that are more likely to be displayed may be buffered more rapidly and made available for local retrieval than peripheral regions that are less likely to be displayed.

In another example, the first peripheral region may be a non-displayed portion of the VR video stream adjacent to the active region. The first peripheral region may surround a portion of the active region. The second peripheral region may be a non-displayed portion of the VR video stream that is adjacent to the first peripheral region. The second peripheral region may surround the first peripheral region and/or the active region. That is, the first peripheral region and the second peripheral region may concentrically surround the active region. In an example, the amount of the second portion of total bandwidth reserved for buffering the first peripheral region located adjacent to and surrounding the active region may be a greater amount than the amount of the third portion of the total bandwidth reserved for buffering the second peripheral region located adjacent to and surrounding the first peripheral region. This example assignment of total bandwidth may result from a determination that in previous utilizations of the VR video stream and/or in previous portions of the current utilization of the VR video stream, the user most commonly causes relatively small shifts spatially from the active region portion of the VR video stream being displayed to peripheral regions. As such, the peripheral regions of the VR video stream that are spatially closer to the active region and are thus more likely to be displayed may be buffered more rapidly and made available for local retrieval than peripheral regions that are spatially further from the active region and thus less likely to be displayed.

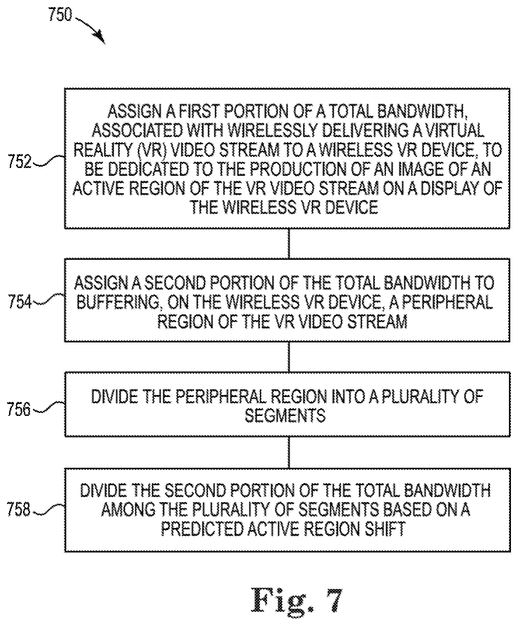

FIG. 7 illustrates a flow diagram of an example of a method 750 for virtual reality buffering consistent with the disclosure. At 752, the method 750 may include assigning a first portion of a total bandwidth to be dedicated to the production of an image of an active region of a VR video stream on a display of a wireless VR device. The total bandwidth may be the total bandwidth available to wirelessly deliver a virtual reality (VR) video stream from a source remote from the wireless VR device to the wireless VR device. For example, the total bandwidth may include the total bandwidth available for wireless data communication, coding, decoding, rendering, displaying, and/or buffering data between the source of a VR video stream and the wireless VR device that is displaying the VR video stream to a user.

At 754, the method 750 may include assigning a second portion of the total bandwidth to buffering a peripheral region of the VR video stream. Buffering the portion of the total bandwidth may include wirelessly communicating, coding, and/or decoding the data associated with producing an image and/or video of the peripheral region on the display of the wireless VR device such that it is stored on a machine-readable medium that is local to and/or incorporated in the wireless VR device. As such, when the wireless VR device needs to display the peripheral region it may be retrieved from machine-readable medium locally instead of over a wireless data connection to the source of the VR video stream.

At 756, the method 750 may include dividing the peripheral region into a plurality of segments. The peripheral region may be divided into segments that align with portions of planes or axes relative to the active region. For example, the peripheral region may be divided into segments that align with a horizontal x-axis or a vertical y-axis relative to the active region. Additionally, the peripheral region may be segmented into a plurality of segments that concentrically surround the active region and/or other peripheral region segments. Further, the peripheral region may be segmented based on regions of a VR video stream that are predicted to be or have previously been viewed by a user of the VR video stream.

At 758, the method 750 may include dividing the second portion of the total bandwidth among the plurality of segments. The second portion of the total bandwidth may be divided among the plurality of segments based on a predicted active region shift. An active region shift may include a change in the region of a VR video stream that is being displayed on a display of the wireless VR device. The active region shift may be induced by a detected movement of a user.

Predicting the active region shift may include predicting the active region shift based on historical data of a prior active region shift into the peripheral region during a prior delivery of the VR video stream. The prior delivery of the VR video stream may include a previous utilization of the VR video stream by the user. The prior delivery of the VR video stream may include a previous portion of a present utilization of the VR video stream. The historical data may include specific indications of portions of the VR environment making up the VR video stream that were previously viewed by the user. Predicting the active region shift may include identifying that, based on the historical data, a shift to a previously viewed peripheral region of the VR video stream is above a threshold likelihood.

Predicting the active region shift may also include predicting the active region shift based on a vector of a prior active region shift into the peripheral region during the delivery of the VR video stream. For example, the speed and/or direction of a previous active region shift identified during a present utilization of the VR video stream may indicate another segment of the peripheral region that will be shifted to in the future moments of the VR video stream. For example, during a utilization of a VR video stream the user may trigger an active region shift panning to the left away from the active region at a rate of five degrees per second. A segment of the peripheral region that is ten degrees to the left away from the active region may be predicted to be a next peripheral region segment to be displayed on the display of the wireless VR device. As such, dividing the second portion of the total bandwidth among the plurality of segments based on a predicted active region shift may include allocating a greater portion of the second portion of the total bandwidth to buffering the predicted next peripheral region segment than other peripheral region segments.

Predicting the active region shift may also include predicting the active region shift based on a biomechanical attribute of a user of the wireless VR device. For example, a predicted next peripheral region segment to be displayed may be identified based on anatomical and/or motor abilities of the user. In an example, predicting the active region shift may include identifying a plurality of segments that are physically possible for and/or above a likelihood threshold to be viewed within a period of time. For example, a human user may have biomechanical limitations upon how rapidly they are able to achieve a one hundred and eighty degree shift in their orientation.

As such, dividing the second portion of the total bandwidth among the plurality of segments based on a predicted active region shift may include prioritizing the access of the plurality of peripheral region segments to bandwidth for buffering over a period of time. If a human is unable or unlikely to achieve a one hundred and eighty degree shift in their orientation over a particular period of time but over the same period of time is capable of achieving a ninety degree shift in their orientation, then the peripheral region segments that lie within ninety degrees from the active region may be allocated more bandwidth for buffering over the period of time that the peripheral region segments that lie outside of ninety degrees from the active region.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 214 may refer to element “14” in FIG. 2, and a similar element may be referenced as 314 in FIG. 3. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a”. “a number of”, and/or “a plurality of” an element and/or feature can refer to one or more of such elements and/or features.

What is claimed:

1. A wireless system comprising:
a wearable display; and
instructions executable by a processor to:
assign a first portion of a total bandwidth, associated with wirelessly delivering a virtual reality (VR) video stream to the wearable display, to instantiate of an image of an active region of the VR video stream on the wearable display; and
assign a second portion of the total bandwidth to buffering a peripheral region of the video stream.

2. The system of claim 1, wherein the peripheral region of the stream includes a portion of the VR video stream that is adjacent to the active region and is not displayed on the display during the assignment.

3. The system of claim 1, further comprising instructions executable by the processor to identify an amount of the total bandwidth available for delivering a VR video stream.

4. The system of claim 1, wherein an amount of the first portion of the total bandwidth and an amount of the second portion of the total bandwidth are determined based on a predicted shift of the active region into the peripheral region for the VR video stream.

5. The system of claim 1, wherein an amount of the first portion of the total bandwidth and an amount of the second portion of the total bandwidth are variable throughout the VR stream.

6. The system of claim 5, wherein the amount of the first portion of the total bandwidth assigned to instantiate the image of the active region is determined based on an amount of data associated with a portion of the VR stream corresponding to the active region.

7. The system of claim 6, wherein the amount of the second portion of the total bandwidth assigned to buffering the peripheral region is determined based on an amount of the total bandwidth remaining after the assignment of the first portion of the total bandwidth.

8. The system of claim 1, further comprising instructions executable by the processor to exclude data of the image of the active region instantiated on the wearable display when an amount of data associated with instantiating the image exceeds an amount of information deliverable utilizing the assigned first portion of the total bandwidth.

9. A non-transitory computer-readable medium containing instructions executable by a processor to cause the processor to:
assign a first portion of a total bandwidth, associated with wirelessly delivering a virtual reality (VR) video stream to a wireless VR device, to the production of an image of an active region of the VR video stream on a wearable display of the wireless VR device;
assign a second portion of the total bandwidth to buffering, on the wireless VR device, a first peripheral region of the VR video stream; and
assign a third portion of the total bandwidth to buffering, on the wireless VR device, a second peripheral region of the VR video stream.

10. The non-transitory computer-readable medium of claim 8, wherein the first peripheral region corresponds to a non-displayed portion of the VR video stream adjacent to the active region along a first axis, and wherein the second peripheral region corresponds to a non-displayed portion of the VR video stream adjacent to the active region along a second axis perpendicular to the first axis.

11. The non-transitory computer-readable medium of claim 8, wherein the first peripheral region corresponds to a non-displayed portion of the VR video stream adjacent to and surrounding the active region, and wherein the second peripheral region corresponds to a non-displayed portion of the VR video stream adjacent to and surrounding the first peripheral region.

12. A method comprising:
assigning a first portion of a total bandwidth, associated with wirelessly delivering a virtual reality (VR) video stream to a wireless VR device, to be dedicated to the production of an image of an active region of the VR video stream on a display of the wireless VR device;
assigning a second portion of the total bandwidth to buffering, on the wireless VR device, a peripheral region of the VR video stream:
dividing the peripheral region into a plurality of segments;
dividing the second portion of the total bandwidth among the plurality of segments based on a predicted active region shift.

13. The method of claim 12, comprising predicting the active region shift based on historical data of a prior active region shift into the peripheral region during a prior delivery of the VR video stream.

14. The method of claim 12, comprising predicting the active region shift based on a vector of a prior active region shift into the peripheral region during the delivery of the VR video stream.

15. The method of claim 12, comprising predicting the active region shift based on a biomechanical attribute of a user of the wireless VR device.
